(19) United States
(12) Patent Application Publication
(10) Pub. No.: US 2026/0159441 A1
(43) Pub. Date: Jun. 11, 2026

(54) METHOD OF MANUFACTURING COVER WINDOW FOR DISPLAY DEVICE, AND ELECTRONIC DEVICE

(71) Applicant: Samsung Display Co., LTD., Yongin-si (KR)

(72) Inventors: Byeong Beom KIM, Yongin-si (KR); Seung Ho KIM, Yongin-si (KR); Jin Su NAM, Yongin-si (KR); Gyu In SHIM, Yongin-si (KR); Jae Gil LEE, Yongin-si (KR)

(21) Appl. No.: 19/180,876

(22) Filed: Apr. 16, 2025

(30) Foreign Application Priority Data
May 24, 2024 (KR) 10-2024-0067492

(51) Int. Cl. C03C 15/00; B23K 26/53; C09K 13/02; C09K 13/08

(52) U.S. Cl. CPC C03C 15/00; B23K 26/53; C09K 13/02; C09K 13/08

(57) ABSTRACT

A method of manufacturing a cover window for a display device includes: etching a window substrate using a first solution; etching the window substrate using a second solution different from the first solution; and etching the window substrate using a third solution different from the first solution and the second solution. The first solution may include a fluorine-based compound, and the third solution may be a basic solution.

This application claims priority to Korean Patent Application No. 10-2024-0067492, filed on May 24, 2024, and all the benefits accruing therefrom under 35 U.S.C. § 119, the content of which in its entirety is herein incorporated by reference.

### BACKGROUND

### 1. Technical Field

The present disclosure generally relates to a method of manufacturing a cover window for a display device and electronic device.

### 2. Related Art

With the development of information technologies, the importance of a display device which is a connection medium between a user and information has been increasing.

A display device may include a cover window capable of allowing an image displayed in the display device to be transmitted therethrough while protecting the display device from an external environment (e.g., impact). It may be desired for the cover window to have excellent characteristics in various properties such as, for example, impact resistance so as to effectively protect the display device from the external environment.

### SUMMARY

Embodiments provide a method of manufacturing a cover window for a display device, in which impact resistance can be improved and manufacturing processes can be simplified.

In accordance with an aspect of the present disclosure, there is provided a method of manufacturing a cover window for a display device, the method including: etching a window substrate using a first solution; etching the window substrate using a second solution different from the first solution; and etching the window substrate using a third solution different from the first solution and the second solution, wherein the first solution includes a fluorine-based compound, and the third solution is a basic solution.

The third solution may include at least one of sodium hydroxide (NaOH) and potassium hydroxide (KOH).

The method may further include: cleaning the window substrate, using the third solution; and reinforcing the window substrate, using the third solution. The reinforcing may include replacing an alkaline ion of the window substrate with at least a portion of a sodium ion (Na⁺) comprised in the sodium hydroxide (NaOH) or a potassium ion (K⁺) comprised in the potassium hydroxide (KOH.

The window substrate may include a plurality of cover windows. The window substrate may include a first area as a boundary area between the plurality of cover windows and a second area as an area in which each of the plurality of cover windows is bendable. The etching of the window substrate using the third solution may include etching the first area and etching the second area.

The method may further include irradiating the first area and the second area of the window substrate with a laser. In the etching of the first area and the etching of the second area, the first area of the window substrate may be etched deeper than the second area of the window substrate.

The method may further include irradiating the first area and the second area of the window substrate with a laser. The irradiating of the first area and the second area of the window substrate with the laser may include irradiating the first area with the laser according to a first intensity and irradiating the second area with the laser according to a second intensity different from the first intensity. Based on the irradiating, the first area may be modified further than the second area by the laser, and an etch rate associated with the first area may be different from an etch rate associated with the second area.

The method may further include: disposing the window substrate in a tray; and disposing a mask on the tray such that the mask is fixed to the tray.

In a plan view, the mask may expose the first area and the second area, and overlap one or more areas other than the first area and the second area.

The etching of the window substrate using the first solution may be performed after the disposing of the mask on the tray.

Each of the cover windows may include flat areas in which the cover window is not bendable. The second area may be disposed between the flat areas. The cover window may have a first thickness in the flat areas and a second thickness in the second area.

A thickness of the cover window may increase in a direction toward an edge from a center of the second area.

The cover window may have a thickness of 70μ to 300μ in the flat area, and the smallest thickness of the cover window in the second area may be less than 70μ. A width of the second area may be 30 mm or less.

Each of the first solution and the second solution may be an acid solution. The second solution may be absent fluorine-based compound.

The first solution may include at least one of hydrofluoric acid (HF), ammonium fluoride (NH₄F), and ammonium bifluoride (NH₄HF₂). The second solution may include sulfuric acid (H₂SO₄).

The etching of the window substrate, using the second solution different from the first solution, may be performed after the etching of the window substrate, using the first solution. The etching of the window substrate, using the third solution different from the first solution and the second solution, may be performed after the etching of the window substrate, using the second solution different from the first solution.

An electronic device includes a processor to provide input image data; and a display device to display an image based on the input image data. The display device is manufactured according to a method including: etching a window substrate using a first solution; etching the window substrate using a second solution different from the first solution; and etching the window substrate using a third solution different from the first solution and the second solution, wherein the first solution includes a fluorine-based compound, and the third solution is a basic solution.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, the example embodiments are provided such that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a schematic plan view of a display device in accordance with an embodiment of the present disclosure.

FIGS. 2 to 4 are schematic perspective views illustrating a display device in accordance with an embodiment of the present disclosure.

FIG. 5 is a schematic perspective view illustrating a cover window in accordance with an embodiment of the present disclosure.

FIG. 6 is a flowchart illustrating a method of manufacturing the cover window in accordance with an embodiment of the present disclosure.

FIGS. 7 and 8 are schematic plan views illustrating process steps of the method of manufacturing the cover window in accordance with an embodiment of the present disclosure.

FIG. 9 is a flowchart illustrating step S500 illustrated in FIG. 6.

FIG. 10 is a flowchart illustrating a method of manufacturing a display device in accordance with an embodiment of the present disclosure.

FIG. 11 is a schematic sectional view of a display device in accordance with an embodiment of the present disclosure.

FIG. 12 is a graph illustrating a strength of the cover window manufactured by the method in accordance with the present disclosure and a strength in accordance with a comparative example.

FIG. 13 is a micrograph obtained by photographing a surface of the comparative example.

FIG. 14 is a micrograph obtained by photographing a surface of the cover window manufactured by the method in accordance with the present disclosure.

FIG. 15 is a schematic block diagram illustrating an electronic device 1000 including a display device in accordance with an embodiment.

FIG. 16 is a schematic diagram illustrating an example where the electronic device 1000 of FIG. 15 is a smartphone.

FIG. 17 is a schematic diagram illustrating an example where the electronic device 1000 of FIG. 15 is a tablet computer.

### DETAILED DESCRIPTION

The present disclosure may apply various changes and different shape, therefore only illustrate in details with particular examples. However, the examples do not limit to certain shapes but apply to all the change and equivalent material and replacement. The drawings included are illustrated a fashion where the figures are expanded for the better understanding.

It will be understood that, although the terms “first”, “second”, and the like may be used herein to describe various elements, these elements should not be limited by these terms. These terms are used to distinguish one element from another element. Thus, a “first” element discussed below could also be termed a “second” element without departing from the teachings of the present disclosure. As used herein, the singular forms are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof. Further, an expression that an element such as, for example, a layer, region, substrate or plate is placed “on” or “above” another element indicates not only a case where the element is placed “directly on” or “just above” the other element but also a case where a further element is interposed between the element and the other element. On the contrary, an expression that an element such as, for example, a layer, region, substrate or plate is placed “beneath” or “below” another element indicates not only a case where the element is placed “directly beneath” or “just below” the other element but also a case where a further element is interposed between the element and the other element.

The terms “about” or “approximately” as used herein are inclusive of the stated value and include a suitable range of deviation for the particular value as determined by one of ordinary skill in the art, considering the measurement in question and the error associated with measurement of the particular quantity. The terms “about” or “approximately” can mean within one or more standard deviations, or within ±30%, 20%, 10%, 5% of the stated value, for example.

The present disclosure generally relates to a method of manufacturing a cover window for a display device. Hereinafter, a method of manufacturing a cover window for a display device in accordance with an embodiment of the present disclosure will be described with reference to the accompanying drawings.

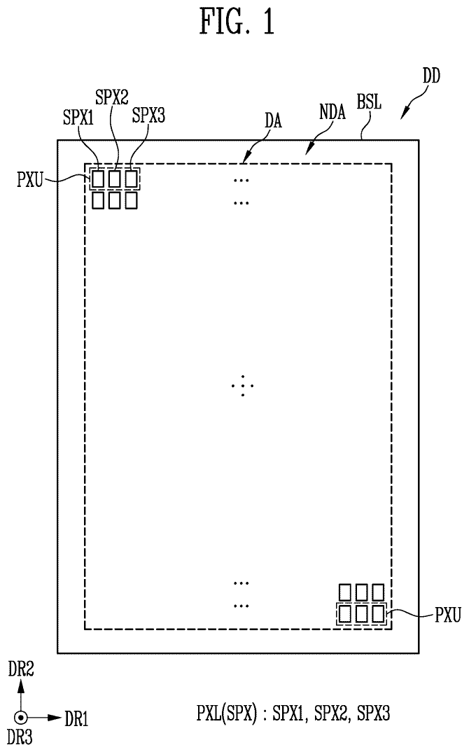

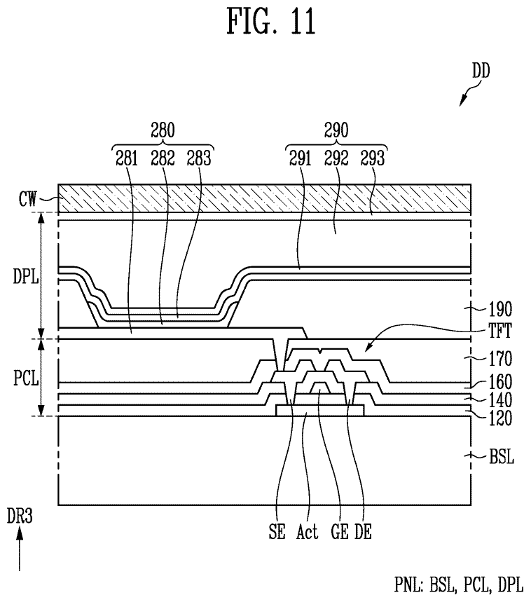

First, a display device DD including a cover window CW (see FIG. 11) will be schematically described with reference to FIGS. 1 to 5.

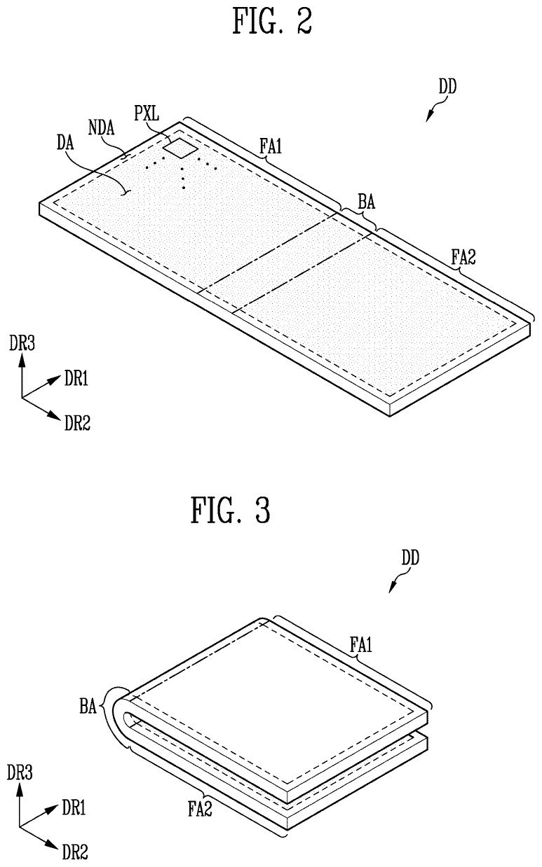

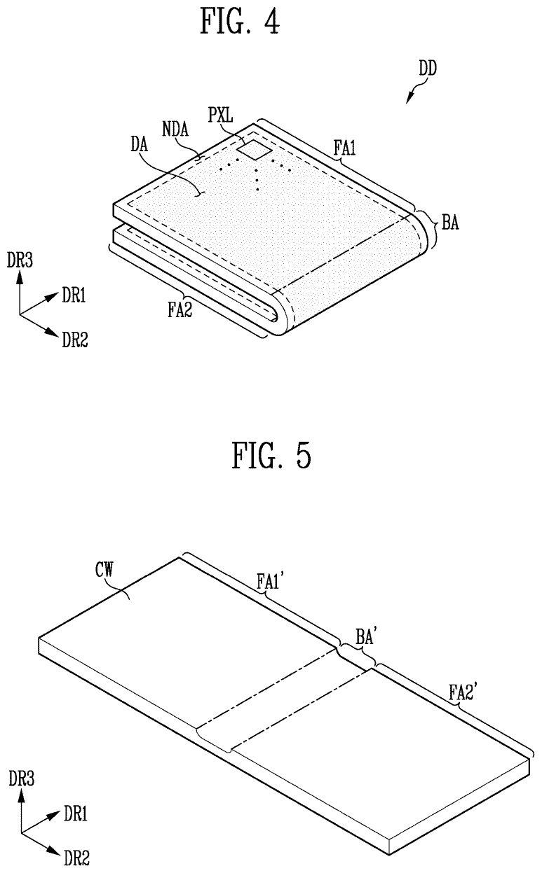

FIG. 1 is a schematic plan view of a display device in accordance with an embodiment of the present disclosure. FIGS. 2 to 4 are schematic perspective views illustrating a display device in accordance with an embodiment of the present disclosure. FIG. 2 illustrates a display device DD having flexible characteristics as an example of the display device DD illustrated in FIG. 1, and illustrates a state in which the display device DD is unfolded. FIGS. 3 and 4 illustrate a first folding state and a second folding state of the display device DD having the flexible characteristics.

Referring to FIG. 1, the display device DD may be configured to emit light. The display device DD may include a light emitting element. In some embodiments, the display device DD may be a display device for displaying moving images or still images. The display device DD may be used as a display screen of not only portable electronic devices such as, for example, a mobile phone, a smart phone, a tablet personal computer (PC), a mobile communication terminal, an electronic notebook, an electronic book, a portable multimedia player (PMP), a navigation system, and an ultra-mobile PC, but also various products such as, for example, a television, a notebook computer, a monitor, an advertisement board, and Internet of things (IOT). However, the application field of the display device DD is not limited to a specific example.

The display device DD may be formed in a rectangular plane having short sides in a first direction DR1 and long sides in a second direction DR2 intersecting the first direction DR1. A corner at which the short side in the first direction DR1 and the long side in the second direction DR2 meet each other may be formed round to have a predetermined curvature or be formed at a right angle. The planar shape of the display device DD is not limited to a quadrangular shape, and the display device DD may be formed in another polygonal shape or a round shape such as, for example, a circular shape or an elliptical shape. The display device DD may be formed flat, but embodiments of the present disclosure are not limited thereto. For example, the display device DD may include a curved portion which is formed at left/right ends and has a constant curvature or a changing curvature.

In the present disclosure, the first direction DR1 may be a “horizontal” direction as a row direction of pixels PXL. The second direction DR2 may be a column direction of pixels PXL. A third direction DR3 may be a display direction of the display device DD or a normal direction of a plane on which a base layer BSL is disposed.

The display device DD may include a display area DA and a non-display area NDA. The non-display area NDA may mean an area other than the display area DA. The non-display area NDA may surround at least a portion of the display area DA.

The display area DA may mean an area in which pixels PXL are disposed. The non-display area NDA may mean an area in which the pixels PXL are not disposed. A driving circuit, lines, and pads, which are connected to the pixels PXL of the display area DA, may be disposed in the non-display area NDA.

In some embodiments, the pixel PXL (or sub-pixels SPX) may include a first sub-pixel SPX1, a second sub-pixel SPX2, and a third sub-pixel SPX3. At least one first sub-pixel SPX1, at least one second sub-pixel SPX2, and at least one third sub-pixel SPX3 may form one pixel unit PXU capable of emitting lights of various colors. In FIG. 1, an example is illustrated in which each pixel PXL includes third sub-pixels SPX1, SPX2, and SPX3, i.e., the first sub-pixel SPX1, the second sub-pixel SPX2, and the third sub-pixel SPX3. However, embodiments of the present disclosure are not limited thereto.

In some embodiments, the pixels PXL (or sub-pixels SPX) may be arranged according to a stripe arrangement structure, a PENTILE™ arrangement structure, or the like. However, the present disclosure is not necessarily limited thereto.

The first sub-pixel SPX1 may emit first light, the second sub-pixel SPX2 may emit second light, and the third sub-pixel SPX3 may emit third light. The first light may be light in a red wavelength band, the second light may be light in a green wavelength band, and the third light may be light in a blue wavelength band. The red wavelength band may be a wavelength band of about 600 nm to about 750 nm, the green wavelength band may be a wavelength band of about 480 nm to about 560 nm, and the blue wavelength band may be a wavelength band of about 370 nm to about 460 nm. However, embodiments of the present disclosure are not limited thereto.

Each of the first sub-pixel SPX1, the second sub-pixel SPX2, and the third sub-pixel SPX3 may include an inorganic light emitting element including an inorganic semiconductor or an Organic Light Emitting Diode (OLED) as the light emitting element emitting light. However, the present disclosure is not limited to a specific example.

The display device DD may be formed flexible enough to be warpable, curvable, bendable, foldable or rollable.

For example, the display device DD may have a flat state or a folding state. For example, the display device DD may be unfolded entirely flat as illustrated in FIG. 2 and be folded as illustrated in FIGS. 3 and 4. The display device DD may include a bendable area BA as an area in which the display device DD is bendable, and a first flat area FA1 and a second flat area FA2 at both sides of the bendable area BA. The first flat area FA1 and the second flat area FA2 may be disposed while being adjacent to (or in contact with) the bendable area BA.

The bendable area BA may be a portion bendable when the display device DD is folded, and each of the first flat area FA1 and the second flat area FA2 may be a portion which is not bendable.

Although one bendable area BA is illustrated in the drawings, the display device DD may include a plurality of bendable areas which are spaced apart from each other or are bendable with different curvature radii. For example, the display device DD may include two or more bendable areas and three or more flat areas.

As illustrated in FIG. 3, the display device DD may be folded (hereinafter, referred to as in-folding) such that portions of a screen face each other, i.e., such that a screen portion of the first flat area FA1 and a screen portion of the second flat area FA2. As illustrated in FIG. 4, the display device DD may be folded (hereinafter, referred to as out-folding) such that a screen is exposed to the outside. In an in-folding state, a screen portion of the bendable area BA may be covered. In an out-folding state, the screen portion of the bendable are BA may be exposed such that a user can view the screen portion of the bendable are BA. The display device DD may be designed such that one of the in-folding and the out-folding is possible or such that both the in-folding and the out-folding are possible. In an example in which the display device DD includes a plurality of bendable area BA, one of the plurality of bendable area BA may be a bendable area in which the in-folding is possible, and another of the plurality of bendable area BA may be a bendable area in which the out-folding is possible.

The display device DD may further include a housing, various components, e.g., a display panel, a driving device, a printed circuit board, an application processor, a memory, a speaker, various types of sensors, and the like may be located in a space limited by the cover window CW and the housing. The display device DD in accordance with the present disclosure includes the cover window CW in accordance with the present disclosure, thereby improving impact resistance.

Hereinafter, a cover window CW will be described with reference to FIG. 5. FIG. 5 is a schematic perspective view illustrating a cover window in accordance with an embodiment of the present disclosure.

Referring to FIG. 5, a bendable area BA′ and flat areas FA1′ and FA2′ at both sides of the bendable area BA′ may be defined in the cover window CW. For example, the cover window CW may include the flat areas FA1′ and FA2′ spaced apart from each other and the bendable area BA′ disposed between the flat areas FA1′ and FA2′. In some embodiments, the flat areas FA1′ and FA2′ may be spaced apart from each other with a distance of 30 mm or less. For example, a width of the bendable area BA′ in the second direction DR2 may be 30 mm or less.

The bendable area BA′ of the cover window CW may be an area corresponding to the bendable area BA of the display device DD when the cover window CW is applied to the display device DD. The bendable area BA′ of the cover window CW may be an area in which the cover window CW is bendable. The bendable area BA′ of the cover window CW may overlap with the bendable area BA of the display device DD in a plan view.

The flat areas FA1′ and FA2′ of the cover window CW may be areas corresponding to the flat areas FA1 and FA2 of the display device DD when the cover window CW is applied to the display device DD. The flat areas FA1′ and FA2′ of the cover window CW may be a roughly flat areas. The flat areas FA1′ and FA2′ of the cover window CW may be areas in which the cover window CW is not bent. The flat areas FA1′ and FA2′ of the cover window CW may respectively overlap with the flat areas FA1 and FA2 of the display device DD in a plan view.

The cover window CW may have a first thickness in the flat areas FA1′ and FA2′ and a second thickness (different from the first thickness) in the bendable area BA′. The cover window CW may have a roughly uniform thickness in the flat areas FA1′ and FA2′. The thickness of the cover window CW may increase in a direction (e.g., second direction DR2) toward an edge from a center of the bendable area BA′. The cover window CW may have a thickness which increases in a direction (e.g., second direction DR2) toward a boundary between the bendable area BA′ and the flat areas FA1′ and FA2′ from the center of the bendable area BA′. The cover window CW may have a smallest thickness at the center of the bendable area BA′.

The cover window CW may have a thickness of 50μ to 300μ in the flat areas FA1′ and FA2′. In some embodiments, the cover window CW may have a thickness of 70μ to 300μ in the flat areas FA1′ and FA2′.

The cover window CW may have a smallest thickness in the bendable area BA′. For example, the smallest thickness of the cover window CW in the bendable area BA′ may be thinner than a smallest thickness of the cover window CW in the flat areas FA1′ and FA2′. In the bendable area BA′, the smallest thickness of the cover window CW may be less than 70μ. In some embodiments, in the bendable area BA′, the smallest thickness of the cover window CW may be 50μ or less. In some embodiments, in the bendable area BA′, the smallest thickness of the cover window CW may be 30μ or less.

In the present disclosure, a thickness may be defined as a direction (e.g., the third direction DR3) perpendicular to the plane on which the base layer BSL is disposed.

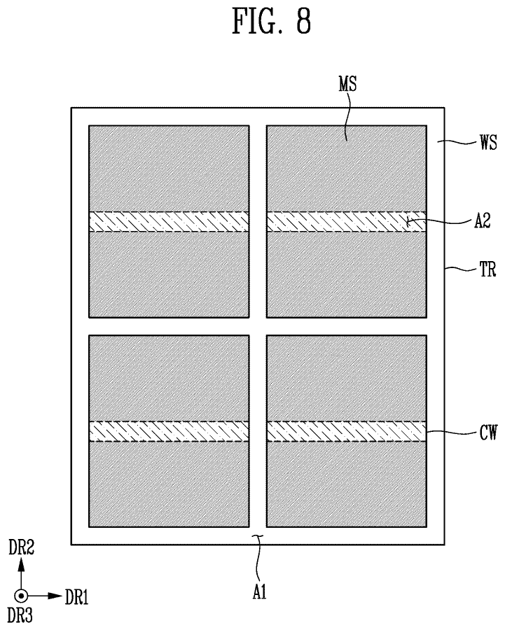

In the cover window CW in accordance with the present disclosure, a mask MS (see FIG. 8) is disposed on the cover window CW when an etching process is performed, and at least a portion of the bendable area BA′ of the cover window CW is etched, such that the cover window CW can have a first thickness in the flat areas FA1′ and FA2′ and a second thickness (different from the first thickness) in the bendable area BA′. The thickness of the cover window CW may be smaller in the bendable area BA′ than a thickness of the cover window CW in the flat areas FA1′ and FA2′, and bending characteristics, such as the reduction of stress when the cover window CW is bent, can be improved.

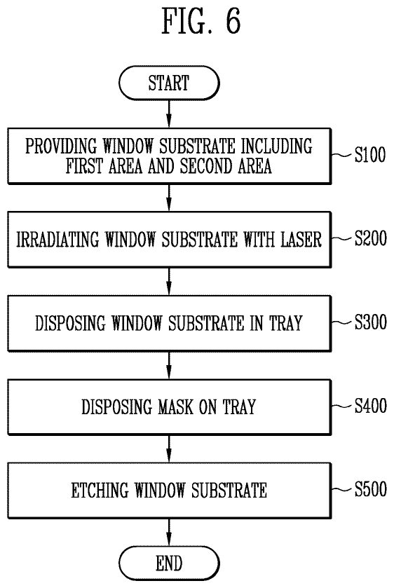

In some aspects, the cover window CW in accordance with the present disclosure is etched, cleaned, and reinforced, using a basic solution, to have improved impact resistance and to be manufactured through a simplified process. Hereinafter, a method of manufacturing the cover window CW will be described with reference to FIGS. 6 to 9.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added. Descriptions that an element “may be disposed,” “may be formed,” and the like include methods, processes, and techniques for disposing, forming, positioning, and modifying the element, and the like in accordance with example aspects described herein.

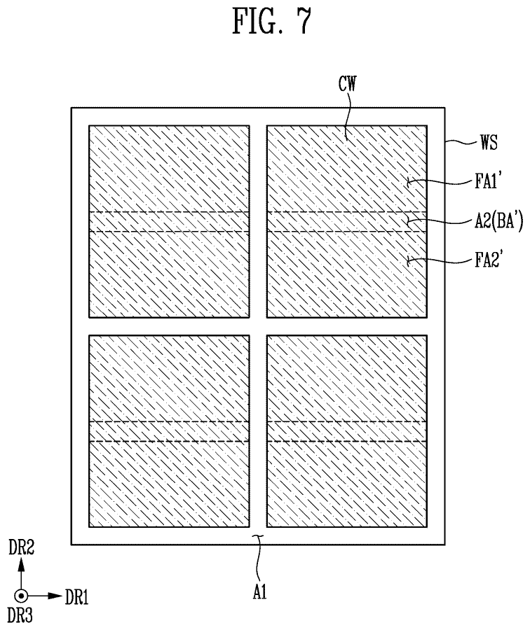

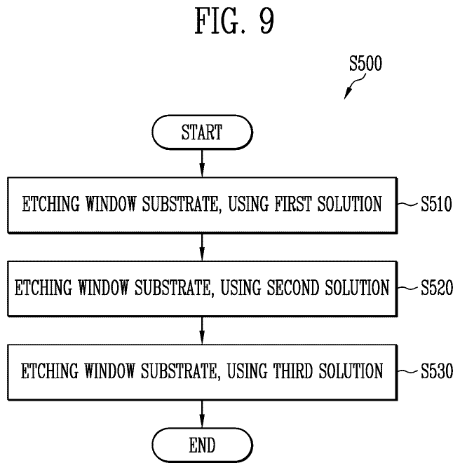

FIG. 6 is a flowchart illustrating a method of manufacturing the cover window in accordance with an embodiment of the present disclosure. FIGS. 7 and 8 are schematic plan views illustrating process steps of the method of manufacturing the cover window in accordance with an embodiment of the present disclosure. FIG. 7 illustrates a schematic plan view of a window substrate WS including a plurality of cover windows CW. The cover window CW in accordance with the present disclosure may be manufactured to be etched and processed from the window substrate WS. FIG. 8 is a schematic plan view illustrating a state in which the window substrate WS is fixed to a tray TR and a mask is disposed on the tray TR. FIG. 9 is a flowchart illustrating step S500 of FIG. 6.

Referring to FIG. 6, the method of manufacturing the cover window CW may include step S100 of providing a window substrate including a first area and a second area, step S200 of irradiating the window substrate WS with a laser (e.g., emitting the laser such that the laser is incident the window substrate WS), step S300 of disposing the window substrate in a tray, step S400 of disposing a mask on the tray, and step S500 of etching the window substrate.

Referring to FIGS. 6 and 7, the step S100 of providing the window substrate may include preparing a optically transparent window substrate WS having a roughly uniform thickness (e.g., a thickness of about 30μ to about 300μ).

The window substrate WS may be ultra-thin glass (UTG). In some embodiments, the window substrate WS may include soda lime glass, alkali alumino silicate glass, borosilicate glass, or lithium alumina silicate glass.

The window substrate WS may be a mother substrate (e.g., a window substrate including a plurality of cover windows CW). The window substrate WS may be a mother substrate for forming the cover window CW. The window substrate WS may be cut and processed to form the cover window CW.

A first area A1 corresponding to a boundary area between a plurality of cover windows CW (e.g., an area for distinguishing a cover window CW in a cell unit), a second area A2 corresponding to a bendable area BA′ of each cover window CW, and flat areas FA1′ and FA2′ at both sides of the bendable are BA′ are defined in the window substrate WS.

The first area A1 may be an area for distinguishing the cover window CW. For example, the cover windows CW may be spaced apart from each other with the first area A1 interposed between the cover windows CW. The first area A1 may be an area overlapping with a cutting line of the window substrate WS in a plan view. For example, the method may include cutting and processing the window substrate WS including the plurality of cover windows CW, along the cutting line formed in the first area A1, such that each cover window CW is formed. The method may include cutting and processing the window substrate WS such that a cover window in a cell unit, which corresponds to the display panel of the display device, is formed.

The second area A2 of the window substrate WS may be an area in which each cover window CW is bendable. For example, the second area A2 may be an area identical to the bendable area BA of the display area DD. The second area A2 may be defined as the bendable area BA′.

The step S200 of irradiating the window substrate WS with the laser may include a step of irradiating (or applying) laser onto the first area A1 of the window substrate WS. The laser irradiated onto the window substrate WS may be a laser beam. Additionally, or alternatively, the laser beam may be a halogen beam. However, embodiments of the present disclosure are not limited thereto.

In some aspects, irradiating a given area (e.g., first area A1) of the window substrate WS with the laser may modify a composition material included in the given area. Modification on the window substrate WS may mean a change in refractive index, a material density, melting, compacting, a change in ablation, or a chemical change in material. In some aspects, the modification may include the formation of a microscopic fissure capable of facilitating infiltration of an etchant or cracking of a material for generating voids. In some aspects, the modification may change a bond angle of silicon oxide (e.g., silica).

Irradiating the first area A1 of the window substrate WS may modify the first area A1. An etching rate of the first area A1 of the window substrate WS as modified due to the irradiation may be higher compared to an area which is not modified (e.g., the flat areas FA1′ and FA2′), such that etching of the first area A1 is improved compared to etching of the area which is not modified. Accordingly, for example, embodiments of the present disclosure include irradiating the window substrate WS with the laser, thereby increasing a selectivity in a subsequent etching process.

In some embodiments, the step S200 of irradiating the window substrate with the laser may include a step of irradiating the second area A2 of the window substrate WS with the laser (e.g., emitting the laser such that the laser is incident the second area A2. The method may include irradiating the second area A2 of the window substrate WS with the laser beam.

In some examples, the step S200 may include irradiating the first area A1 with the laser according to a first intensity and irradiating the second area A2 with the laser according to a second intensity different from the first intensity. For example, the method may include irradiating the first area A1 and the second area A2 according to different respective intensities such that the first area A1 is modified further (e.g., etched deeper) than the second area A2. Based on the irradiation of the first area A1 and the second area A2 with the laser, the first area A1 may be modified further than the second area A2. For example, based on the irradiating of the first area A1 and the second area A2 with the laser according to different respective intensities, the first area A1 may be modified to have a selectivity (e.g., an etch selectivity of each of first to third solutions which will be described later) different from a selectivity of the second area A2. The irradiation may modify the first area A1 to have an etch rate (e.g., an etch rate of each of the first to third solutions) greater than an etch rate of the second area A2. Accordingly, for example, the second area A2 may be etched less than the first area A1 when the window substrate WS is etched. The second area A2 may be etched faster compared to areas which are not modified (e.g., the flat areas FA1′ and FA2′).

After performing the step S200 of irradiating the window substrate WS with the laser, the method may include performing the step S300 of disposing the window substrate in the tray so as to later perform an etching process (e.g., at step S500) on the window substrate WS. The method may include disposing the window substrate WS in a tray TR (see FIG. 8) and transporting the window substrate WS and tray TR to a bath for the etching process.

The method may include using the tray TR to load, transport, and store the window substrate WS. For example, the method may include using the tray TR for loading and storing the window substrate WS and then transporting the window substrate WS to the bath.

When the window substrate WS is disposed in the tray TR and then dipped into the bath, a risk that the window substrate WS will not be appropriately fixed in the tray TR may exist. In an example in which the etching process is performed, floating of the window substrate WS may occur due to an etchant in the bath.

Accordingly, for example, the method of manufacturing the cover window CW in accordance with embodiments of the present disclosure may further include the step S400 of disposing the mask on the tray after the step S300 of disposing the window substrate in the tray such that the window substrate WS is appropriately fixed to the tray TR.

Referring to FIG. 8, in the step S400 of disposing the mask on the tray, the method may include disposing a mask MS on the window substrate WS and the tray TR. The window substrate WS may be disposed between the mask MS and the tray TR. The mask MS may be fixed to the tray TR, and be disposed on the window substrate WS to prevent the floating of the window substrate WS.

Embodiments of the present disclosure may include changing an arrangement relationship (or structure) of the mask MS according to an area in which the window substrate WS is to be etched. In an example in which an area of the window substrate WS is to be etched, the method may include disposing the mask MS such that the mask MS exposes the area of the window substrate WS.

For example, the mask MS may expose the first area A1 and the second area A2 of the window substrate WS. The mask MS may cover one or more areas other than the first area A1 and the second area A2 of the window substrate WS. For example, the mask MS may not overlap with the first area A1 and the second area A2 of the window substrate WS in a plan view. For example, the mask MS may overlap one or more areas other than the first area A1 and the second area A2 of the window substrate WS in a plan view.

The method may include fixing the window substrate WS to the tray TR by the mask MS and then moving the window substrate WS to the bath for etching. For example, after the step S400 of disposing the mask MS on the tray, the method may include moving the window substrate WS to the bath, and later performing the step S500 of etching the window substrate (e.g., step S510 of etching the window substrate WS using a first solution, which will be described later).

Therefore, based on the dipping of the window substrate WS into the etchant in the bath, the first area A1 and the second area A2, which are exposed to the etchant, may be etched, and a portion covered by the mask MS may not be etched. Alternatively, based on the dipping of the window substrate WS into the etchant in the bath, the first area A1 and the second area A2, which are exposed to the etchant, may be etched further than the first area A1 and the second area A2, which are covered by the mask MS.

According to the method of manufacturing the cover window CW in accordance with an embodiment of the present disclosure, the step S500 of etching the window substrate is performed after the step S400 of disposing the mask on the tray, such that the window substrate WS can be appropriately fixed in the tray TR.

Referring to FIG. 9, the step S500 of etching the window substrate may include step S510 of etching the window substrate WS using a first solution, step S520 of etching the window substrate WS using a second solution, and step S530 of etching the window substrate WS using a third solution. In the present disclosure, the etching of the window substrate WS may include wet etching such as, for example, a spray method, a dip method, or a down-flow method. However, embodiments of the present disclosure are not limited thereto. In the present disclosure, for convenience, an embodiment in which the window substrate WS is etched using the dip method will be described.

In the step S510 of etching the window substrate WS using the first solution, the method may include etching the window substrate WS using a first solution including a fluorine-based compound. Specifically, the method may include immersing (e.g., dipping) the window substrate WS in the first solution, thereby etching the first area A1 and the second area A2 of the window substrate WS. That is, a first etching bath may be filled with the first solution, and the window substrate WS may be moved to the first etching bath to be immersed. After immersion of the window substrate WS (e.g., for a given period of time), the method may include removing the window substrate WS from the first etching bath.

The first solution may be an acid solution. An acid solution means a solution of which hydrogen ion concentration (hereinafter, referred to as pH) is less than 7. Alternatively, a basic solution means a solution of which hydrogen ion concentration (pH) exceeds 7. The first solution may include a fluorine-based compound. The fluorine-based compound may chemically react with at least some of the materials constituting the window substrate WS, thereby melting the window substrate WS or at least partially dissolving portions of the window substrate WS. Accordingly, a surface of the window substrate WS, which is exposed to the first solution including the fluorine-based compound, can be uniformly melted using the first solution.

The fluorine-based compound included in the first solution may be a compound in which fluorine ions or polyatomic ions are dissociated. For example, the fluorine-based compound may include at least one of hydrofluoric acid (HF), ammonium fluoride (NH₄F), and ammonium bifluoride (NH₄HF₂), but embodiments of the present disclosure are not limited thereto. In some embodiments, the fluorine-based compound is a main component of the first solution, and the first solution may further include an inorganic acid or an organic acid.

The fluorine-based compound may improve an etching rate of the window substrate WS. Specifically, the fluorine-based compound may melt a surface of the window substrate WS within a relatively short amount of time, and accordingly, micro-defects existing on the surface of the window substrate WS may be removed using the first solution within a relatively short amount of time. The fluorine-based compound may remove a Heat Affected Zone (HAZ) caused by laser irradiation. However, the fluorine-based compound may chemically react with metal ions existing on the surface of the window substrate WS, thereby forming insoluble fluoride. The insoluble fluoride may be located on the surface of the window substrate WS, and the presence of the insoluble fluoride on a portion of the window substrate WS may prevent the etching of the window substrate WS, which is located under the insoluble fluoride, by the first solution. As a result, roughness of the surface of the window substrate WS may be increased, and micro-defects of the surface of the window substrate WS may not be completely removed.

In some embodiments, the method of manufacturing the cover window CW may further include a step of cleaning the window substrate WS, using De-Ionized (DI) water. The method may include performing the step of cleaning the window substrate WS using the DI water, before performing the step S520 of etching the window substrate WS using the second solution, and after the step S510 of etching the window substrate WS using the first solution. In the window substrate WS etched by the first solution, the DI water may clean impurities (e.g., the insoluble fluoride) on the surface of the window substrate WS.

The window substrate WS etched by the first solution may be immersed in the bath including the DI water. Alternatively, the DI water may be sprayed onto the window substrate WS etched by the first solution.

The method may include performing the step S520 of etching the window substrate WS using the second solution, after the step S510 of etching the window substrate WS using the first solution. In the step S520 of etching the window substrate WS using the second solution, the window substrate WS may be etched using the second solution different from the first solution. Specifically, the method may include immersing (or dipping) the window substrate WS in the second solution, thereby further etching the first area A1 and the second area A2 of the window substrate WS. That is, the first etching bath may be filled with the second solution, and the window substrate WS may be moved to a second etching bath to be immersed. After that, the method may include removing the window substrate WS from the second etching bath.

The second solution may be an acid solution. The second solution may be absent any fluorine-based compound. The second solution may be absent fluorine (F). For example, the second solution may include sulfuric acid (H₂SO₄). However, embodiments of the present disclosure are not limited thereto. In some embodiments, the second solution may include at least one of nitric acid (HNO3) and hydrochloric acid (HCl).

The second solution may be absent fluorine-based compound, and react with the window substrate WS, thereby forming no insoluble fluoride. In some aspects, the second solution may chemically react with at least some of the materials constituting the window substrate WS, thereby melting the window substrate WS or at least partially dissolving portions of the window substrate WS. In this process, the insoluble fluoride on the window substrate WS may be additionally removed, and the roughness of the surface of the window substrate WS may be decreased.

In some aspects, the second solution may remove some of metal ions of the surface of the window substrate WS, and a portion from which the metal ions are removed may exist as an empty space. Accordingly, for cases in which an impact is applied from the outside of the cover window CW, the empty space may reduce the impact, and the strength of the cover window CW can be improved.

The method may include, after the step S520 of etching the window substrate WS using the second solution, performing the step S530 of etching the window substrate WS using the third solution. In the step S530 of etching the window substrate WS using the third solution, the window substrate WS may be etched using the third solution different from the first solution and the second solution. Specifically, the method may include immersing (or dipping) the window substrate WS in the third solution, thereby further etching the first area A1 and the second area A2 of the window substrate WS. That is, the second etching bath may be filled with the third solution, and the window substrate WS may be moved to a third etching bath to be immersed. After that, the method may include removing the window substrate WS from the third etching bath.

In the step S530 of etching the window substrate WS using the third solution, the first area A1 of the window substrate WS may be etched deeper (or further) than the second area A2 of the window substrate WS, and the window substrate WS may be separated into individual cover windows CW. Further, in the step S530 of etching the window substrate WS using the third solution, a portion of the second area A2 of the window substrate WS may be etched, and the second area A2 may be etched deeper (or further) than the flat areas FA1′ and FA2′. The second area A2 of the window substrate WS may have a thickness less than a thickness of the flat areas FA1′ and FA2′.

The third solution may be a basic solution. The basic solution may chemically react with at least some of the materials constituting the window substrate WS, thereby melting glass or at least partially dissolving portions of the glass. Accordingly, although the insoluble fluoride generated as the first solution chemically reacts with the metal ions of the window substrate WS exists on the surface of the window substrate WS, the basic solution can effectively remove the insoluble fluoride. The third solution may include at least one of sodium hydroxide (NaOH) and potassium hydroxide (KOH), but embodiments of the present disclosure are not limited thereto.

The third solution may be absent a fluorine-based compound. The cover window CW in accordance with the present disclosure may be manufactured by etching the window substrate WS using the third solution. Accordingly, the roughness of the surface of the window substrate WS can be reduced, and micro-defects existing on a surface of the cover window CW can be minimized.

The step S530 of etching the window substrate WS using the third solution, may include a step of cleaning the window substrate WS, using the third solution and a step of reinforcing the window substrate WS using the third solution. In an example, the step S530 of etching the window substrate WS using the third solution, the step of cleaning the window substrate WS using the third solution, and the step of reinforcing the window substrate WS using the third solution, may be performed integrally (e.g., in the same bath, or simultaneously).

In the step S530 of etching the window substrate WS using the third solution, the window substrate WS may be cleaned while being cleaned. By cleaning the window substrate WS using the third solution, foreign matters existing on the surface of the window substrate WS may be removed.

In the step S530 of etching the window substrate WS using the third solution, the other portion of the window substrate WS, which is not etched, may be reinforced while the window substrate WS is etched. In the step of reinforcing the window substrate WS using the third solution, the strength of a surface of a glass substrate may be reinforced using ion exchange made on the surface of the window substrate WS. The step of reinforcing the window substrate WS using the third solution, may include a step of replacing an ion of the window substrate WS with an ion included in the third solution. In an example in which the window substrate WS is immersed in the third solution, at least a portion of a sodium ion (Na⁺) or a potassium ion (K⁺) included in the third solution may be exchanged with an alkaline ion of the window substrate WS. The sodium ion (Na⁺) or the potassium ion (K⁺) may be larger than the alkaline ion of the window substrate WS, and form compressive stress in cooling, thereby increasing the strength of the window substrate WS. For example, the window substrate WS on which a reinforcing process is performed in accordance with one or more embodiments of the present disclosure may have improved scratch resistance of the surface as compared with a window substrate on which the reinforcing process is not performed.

In the method of manufacturing the cover window CW in accordance with the present disclosure, the window substrate WS is etched, cleaned, and reinforced using the third solution. Thus, processes of etching, cleaning, and reinforcing the window substrate WS can be integrally performed, and the method of manufacturing the cover window CW can be simplified. Further, as the window substrate WS is etched using the third solution, defects existing on the surface of the window substrate WS are removed, such that the roughness of the surface of the window substrate WS can be reduced. Furthermore, as the strength of the cover window CW is reinforced, impact resistance can be improved. In some aspects, in accordance with the present disclosure, as the cover window CW has a reinforced strength, the method of manufacturing the cover window CW may be performed such that a process of stacking and then cutting the window substrate WS is not separately performed before the step S500 of etching the window substrate.

In the step S530 of etching the window substrate WS using the third solution, the method may include cutting (or etching) the window substrate WS into each cover window CW to be attached to a panel layer PNL of the display device DD.

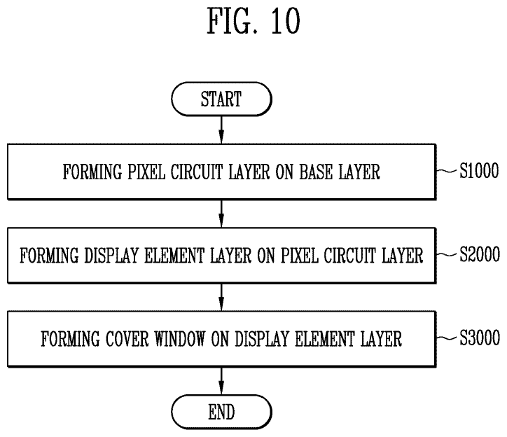

Hereinafter, a method of manufacturing a display device DD including a cover window CW will be described with reference to FIGS. 10 and 11. FIG. 10 is a flowchart illustrating a method of manufacturing a display device in accordance with an embodiment of the present disclosure. FIG. 11 is a schematic sectional view of a display device in accordance with an embodiment of the present disclosure.

Referring to FIG. 10, the method of manufacturing the display device DD may include step S1000 of forming a pixel circuit layer on a base layer, step S2000 of forming a display element layer on the pixel circuit layer, and step S3000 of forming a cover window on the display element layer.

Referring to FIG. 11, the step S1000 of forming the pixel circuit layer on the base layer may include a step of forming a transistor on a base layer, a step of forming insulating layers, and a step of forming a planarization layer.

A base layer BSL may include various materials having flexible or bendable characteristics. For example, the base layer BSL may include glass, metal or polymer resin. In some embodiments, the base layer BSL may include polymer resin such as, for example, polyethersulfone, polyacrylate, polyetherimide, polyethylene naphthalate, polyethylene terephthalate, polyphenylene sulfide, polyarylate, polyimide, polycarbonate, or cellulose acetate propionate.

A pixel circuit layer PCL may include a transistor TFT, insulating layers 120, 140, and 160, and a planarization layer 170.

The transistor TFT may include a semiconductor layer Act including amorphous silicon, polycrystalline silicon, an oxide semiconductor material or an organic semiconductor material, a gate electrode GE, a source electrode SE, and a drain electrode DE.

In some embodiments, in order to secure an insulating property between the semiconductor layer Act and the gate electrode GE, a first insulating layer (or gate insulating layer) 120 including an inorganic material may be interposed between the semiconductor layer Act and the gate electrode GE. For example, the inorganic material may include at least one of silicon nitride (SiNₓ), silicon oxide (SiOₓ), silicon oxynitride (SiOₓN_{y}), and aluminum oxide (AlOₓ).

A second insulating layer (or first interlayer insulating layer) 140 including an inorganic material may be disposed over the gate electrode GE, and a third insulating layer (or second interlayer insulating layer) 160 including an inorganic material may be disposed such that the inorganic material covers the source electrode SE and the drain electrode DE.

In some aspects, the planarization layer 170 may be disposed over the transistor TFT. The planarization layer 170 may function to roughly planarize the top of the transistor TFT. In some embodiments, the planarization layer 170 may include an organic material. However, embodiments of the present disclosure are not limited thereto. In some embodiments, the planarization layer 170 may include an inorganic material. In FIG. 11, it is illustrated that the planarization layer 170 is provided as a single layer. However, embodiments of the present disclosure are not limited thereto.

The step S2000 of forming the display element layer on the pixel circuit layer may include a step of forming a light emitting element electrically connected to the transistor above the transistor, a step of forming a pixel defining layer, and a step of forming an encapsulation layer. A display element layer DPL may include a light emitting element 280, a pixel defining layer 190, and an encapsulation layer 290.

The light emitting element 280 may be an organic light emitting element having a first electrode 281, a second electrode 283, and a light emitting layer 282 interposed between the first electrode 281 and the second electrode 283. However, embodiments of the present disclosure are not limited thereto, and the light emitting element 280 may be an inorganic light emitting element. That the light emitting element 280 is electrically connected to the transistor TFT may be understood as that the first electrode 281 of the organic light emitting element is electrically connected to the transistor TFT.

The first electrode 281 may be electrically connected to the transistor TFT while being in contact with any one of the source electrode SE and the drain electrode DE through an opening formed in the planarization layer 170 and the like as illustrated in FIG. 11. The first electrode 281 may include a transmissive conductive layer formed of a conductive oxide having transmissivity, such as, for example, indium tin oxide (ITO), indium oxide (In₂O₃) or indium zinc oxide (IZO), and a reflective layer formed of a metal such as, for example, Al or Ag. For example, the first electrode 281 may have a triple structure of ITO/Ag/ITO. However, embodiments of the present disclosure are not limited thereto.

The pixel defining layer 190 may be disposed on the planarization layer 170. The pixel defining layer 190 may have an opening corresponding to each pixel, i.e., an opening exposing a central portion of at least the first electrode 281, which may function to define the pixel. The pixel defining layer 190 may include an organic material. However, embodiments of the present disclosure are not limited thereto, and in some examples, the pixel defining layer 190 may include an inorganic material.

The second electrode 283 may be integrally formed in a plurality of organic light emitting elements to correspond to a plurality of first electrodes 281. The second electrode 283 may include a conductive oxide having transmissivity, such as, for example, indium tin oxide (ITO), indium oxide (In₂O₃) or indium zinc oxide (IZO), and include a semi-transmitting film including a metal such as, for example, Al or Ag. For example, the second electrode 283 may be a semi-transmitting film including Mg or Ag.

The encapsulation layer 290 for protecting the light emitting element 280 may be disposed over the light emitting element 280. The encapsulation layer 290 may cover the light emitting element 280.

The encapsulation layer 290 may include a first inorganic encapsulation layer 290, an organic encapsulation layer 292, and a second inorganic encapsulation layer 293. The first inorganic encapsulation layer 291 may cover the second electrode 283 and include an inorganic material. For example, the inorganic material may include at least one of silicon nitride (SiNₓ), silicon oxide (SiOₓ), silicon oxynitride (SiOₓN_{y}), and aluminum oxide (AlOₓ). In some embodiments, other layers such as, for example, a capping layer may be interposed between the first inorganic encapsulation layer 291 and the second electrode 283.

The organic encapsulation layer 292 may cover the first inorganic encapsulation layer 291. The organic encapsulation layer 292 may include an organic material. For example, the organic material may include at least one of acrylic resin, epoxy resin, a phenolic resin, polyamide resin, polyimide resin, and benzocyclobutene (BCB).

The second inorganic encapsulation layer 293 may cover the organic encapsulation layer 292 and include an inorganic material.

A cover window CW may be disposed on the top of the encapsulation layer 290. The cover window CW may be the cover window CW manufactured according to the methods described herein of manufacturing the cover window CW in accordance with the present disclosure.

The display device DD may include a panel layer PNL implementing a screen, and the cover window CW covering the panel layer PNL. The cover window CW may be disposed on the panel layer PNL and be adhered to the panel layer PNL. For example, the cover window CW may be adhered to the panel layer PNL by a pressure sensitive adhesive (PSA). The cover window CW may be disposed on the top of the panel layer PNL to protect the panel layer PNL from external impact.

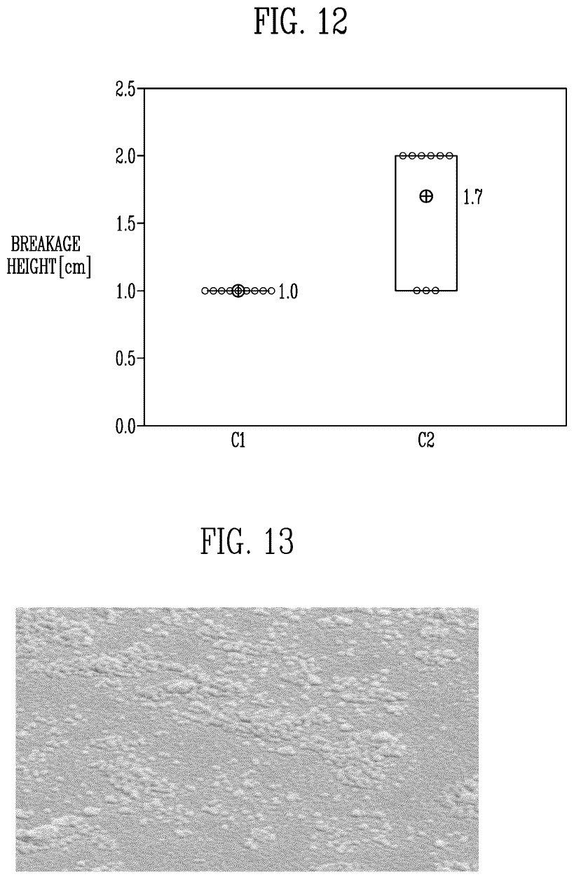

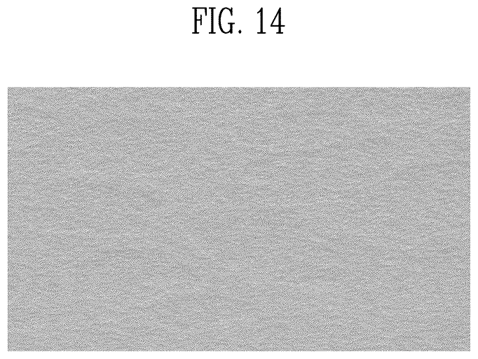

Hereinafter, properties of the cover window CW will be described with reference to FIGS. 12 to 14. FIG. 12 is a graph illustrating a strength of the cover window manufactured by a method in accordance with the present disclosure and a strength in accordance with a comparative example. FIG. 13 is a micrograph obtained by photographing a surface of the comparative example. FIG. 14 is a micrograph obtained by photographing a surface of the cover window manufactured by the method in accordance with the present disclosure.

Referring to FIG. 12, each of strength evaluation results of a first cover window C1 manufactured by a method in accordance with a comparative example and a second cover window C2 manufactured by a method in accordance with an embodiment of the present disclosure is illustrated. Specifically, in FIG. 12, result values of a drop test are illustrated so as to evaluate impact resistance.

The drop test was performed by freely dropping the same ball-point pen vertically on the first cover window C1 and the second cover window C2 and measuring a height at which each of the first cover window C1 and the second cover window C2 is broken by the ball-point pen.

The first cover window C1 corresponds to a cover window etched and cleaned using the first solution including hydrofluoric acid (HF) (e.g., using only the first solution). The second cover window C2 corresponds to a cover window manufactured through the step S510 of etching the window substrate WS using the first solution, the step S520 of etching the window substrate WS using the second solution, and the step S530 of etching the window substrate WS using the third solution. In an example in which the second cover window C2 was manufactured, the first solution including the hydrofluoric acid (HF), the second solution including the sulfuric acid (H₂SO₄), and the third solution including at least one of the sodium hydroxide (NaOH) and the potassium hydroxide (KOH) were used. Each of the first cover window C1 and the second cover window C2 was manufactured by etching the window substrate WS to have a thickness of 30μ in the bendable area BA′.

The first cover window C1 may have a result value distributed in the vicinity of 1.0 cm, and the first cover window C1 may have impact resistance against the ball-point pen dropped at a height of average 1.0 cm. The second cover window C2 may have a result value distributed in a range of 1.0 cm to 2.0 cm, and the second cover window C2 may have impact resistance against the ball-point pen dropped at a height of average 1.7 cm.

That is, the second cover window C2 manufactured by the method in accordance with an embodiment of the present disclosure can have improved impact resistance as compared with the first cover window C1 manufactured by the method in accordance with the comparative example. In other words, the method of manufacturing the cover window further includes the step S520 of etching the window substrate WS using the second solution, and the step S530 of etching the window substrate WS using the third solution, such that the cover window CW having improved strength can be manufactured.

The strength of the surface of the cover window CW may be related to the roughness of the cover window CW. Specifically, as the roughness of the surface of the cover window CW becomes larger, cracks may be more easily propagated by external impact, and therefore, the strength of the cover window CW may become low.

Referring to FIGS. 13 and 14, it can be seen that a roughness of a surface of the second cover window C2 is smaller than a roughness of a surface of the first cover window C1. This is because, by the step of etching and cleansing the window substrate WS using the third solution, insoluble fluoride of the surface of the second cover window C2 was removed and micro-defects were reduced.

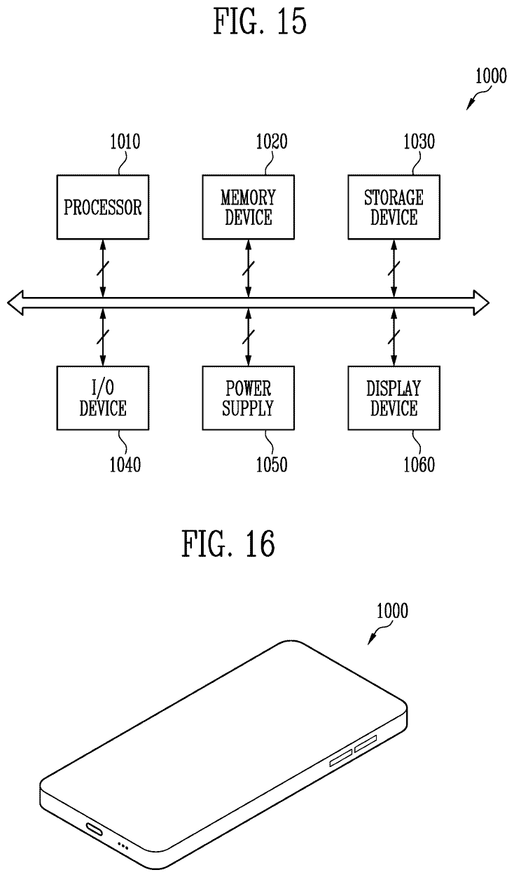

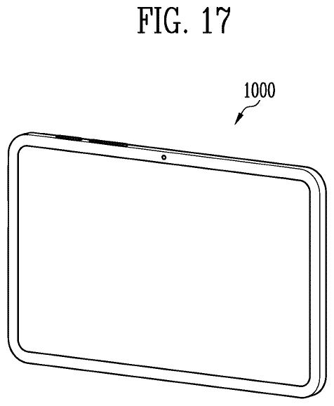

FIG. 15 is a schematic block diagram illustrating an electronic device 1000 including a display device in accordance with an embodiment. FIG. 16 is a schematic diagram illustrating an example where the electronic device 1000 of FIG. 15 is a smartphone. FIG. 17 is a schematic diagram illustrating an example where the electronic device 1000 of FIG. 15 is a tablet computer.

Referring to FIGS. 15 to 17, the electronic device 1000 may include a processor 1010, a memory device 1020, a storage device 1030, an input/output (I/O) device 1040, a power supply 1050, and a display device 1060. The display device 1060 may be the display device DD of FIG. 1. The electronic device 1000 may further include various ports for communication with a video card, a sound card, a memory card, a USB device, or other systems. In an embodiment, as illustrated in FIG. 16, the electronic device 1000 may be a smartphone. In an embodiment, as illustrated in FIG. 17, the electronic device 1000 may be a tablet computer. However, the aforementioned examples are illustrative, and the electronic device 1000 is not necessarily limited to the aforementioned examples. For example, the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. in an embodiment, the processor 1010 may include at least one of a central processing unit, an application processor, a graphic processing unit, a communication processor, an image signal processor, a controller, or the like. The processor 1010 may be connected to other components through an address bus, a control bus, a data bus, and the like. In an embodiment, the processor 1010 may be connected to an expansion bus such as a peripheral component interconnect (PCI) bus. In an embodiment, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device 1000. For example, the power supply 1050 may include a power management integrated circuit (PMIC). In an embodiment, the power supply 1050 may supply power to the display device 1060.

The display device 1060 may display images in response to image data signals and/or control signals from the processor 1010. The display device 1060 may be connected to other components through the buses or other communication links.

In accordance with the present disclosure, a method of manufacturing a cover window for a display device is provided which may improve impact resistance and simplify manufacturing processes.

Example embodiments have been disclosed herein, and although specific terms are employed, they are used and are to be interpreted in a generic and descriptive sense and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method of manufacturing a cover window for a display device, the method comprising:
etching a window substrate using a first solution;
etching the window substrate using a second solution different from the first solution; and
etching the window substrate using a third solution different from the first solution and the second solution,
wherein:
the first solution comprises a fluorine-based compound, and
the third solution is a basic solution.

2. The method of claim 1, wherein the third solution comprises at least one of sodium hydroxide (NaOH) and potassium hydroxide (KOH).

3. The method of claim 2, further comprising:
cleaning the window substrate using the third solution; and
reinforcing the window substrate using the third solution,
wherein the reinforcing comprises replacing an alkaline ion of the window substrate with at least a portion of a sodium ion (Na⁺) comprised in the sodium hydroxide (NaOH) or a potassium ion (K⁺) comprised in the potassium hydroxide (KOH).

4. The method of claim 1, wherein:
the window substrate comprises a plurality of cover windows,
the window substrate comprises:
a first area as a boundary area between the plurality of cover windows; and
a second area as an area in which each of the plurality of cover windows is bendable, and
the etching of the window substrate using the third solution comprises etching the first area and etching the second area.

5. The method of claim 4, further comprising irradiating the first area and the second area of the window substrate with a laser,
wherein, in the etching of the first area and the etching of the second area, the first area of the window substrate is etched deeper than the second area of the window substrate.

6. The method of claim 4, further comprising irradiating the first area and the second area of the window substrate with a laser,
wherein the irradiating of the first area and the second area of the window substrate comprises irradiating the first area with the laser according to a first intensity and irradiating the second area with the laser according to a second intensity different from the first intensity, and
wherein, based on the irradiating, the first area is modified further than the second area by the laser, and an etch rate associated with the first area is different from an etch rate associated with the second area.

7. The method of claim 4, further comprising:
disposing the window substrate in a tray; and
disposing a mask on the tray such that the mask is fixed to the tray.

8. The method of claim 7, wherein, in a plan view, the mask:
exposes the first area and the second area, and
overlaps one or more areas other than the first area and the second area.

9. The method of claim 7, wherein the etching of the window substrate using the first solution is performed after the disposing of the mask on the tray.

10. The method of claim 4, wherein:
each of the cover windows comprises flat areas in which the cover window is not bendable,
the second area is disposed between the flat areas, and
the cover window has a first thickness in the flat areas and a second thickness in the second area.

11. The method of claim 10, wherein a thickness of the cover window increases in a direction toward an edge from a center of the second area.

12. The method of claim 10, wherein:
the cover window has a thickness of 70μ to 300μ in the flat area, and a smallest thickness of the cover window in the second area is less than 70μ, and
a width of the second area is 30 mm or less.

13. The method of claim 1, wherein:
each of the first solution and the second solution is an acid solution, and
the second solution is absent fluorine-based compound.

14. The method of claim 1, wherein:
the first solution comprises at least one of hydrofluoric acid (HF), ammonium fluoride (NH₄F), and ammonium bifluoride (NH₄HF₂), and
the second solution comprises sulfuric acid (H₂SO₄).

15. The method of claim 1, wherein:
the etching of the window substrate using the second solution different from the first solution is performed after the etching of the window substrate using the first solution, and
the etching of the window substrate using the third solution different from the first solution and the second solution is performed after the etching of the window substrate using the second solution different from the first solution.

16. An electronic device, comprising:
a processor to provide input image data; and
a display device to display an image based on the input image data,
wherein the display device is manufactured according to the method of claim 1.
